(19) United States
(12) Patent Application Publication
(10) Pub. No.: US 2022/0341737 A1
(43) Pub. Date: Oct. 27, 2022

(54) METHOD AND DEVICE FOR NAVIGATING

(71) Applicant: BEIJING BAIDU NETCOM SCIENCE TECHNOLOGY CO., LTD., Beijing (CN)

(72) Inventor: Xuecen SHEN, Beijing (CN)

(21) Appl. No.: 17/862,929

(22) Filed: Jul. 12, 2022

(30) Foreign Application Priority Data
Jul. 15, 2021 (CN) 202110801899.7

(51) Int. Cl. G01C 21/16; G01C 21/00

(52) U.S. Cl. CPC G01C 21/165; G01C 21/005

(57) ABSTRACT

A navigation method is provided. The method relates to the field of computer technologies, and in particular, to the field of augmented reality technologies and visual navigation technologies. An implementation is: in response to resumption of navigation after interruption, calculating an initial angle of an inertial sensor based on an angle of a gyroscope; and continuing the navigation based on the initial angle of the inertial sensor and a position of a visual odometry device before the interruption.

### CROSS REFERENCE TO RELATED APPLICATIONS

This application claims priority to Chinese Patent Application No. 202110801899.7, filed on Jul. 15, 2021, the contents of which are hereby incorporated by reference in their entirety for all purposes.

### TECHNICAL FIELD

The present disclosure relates to the field of computer technologies, and in particular, to the field of augmented reality technologies and visual navigation technologies, and particularly relates to a navigation method, an apparatus, a navigation device, an electronic device, a computer-readable storage medium, and a computer program product.

### BACKGROUND

In outdoor navigation, a global positioning system (GPS) module and an electronic compass are usually used for positioning and orienting. However, in indoor positioning, because GPS signals are weak, the GPS module cannot be used for effective positioning. In addition, due to a complex indoor magnetic field environment, The directional signal output by the electronic compass is susceptible to interference, the electronic compass cannot be used for effective orienting.

Therefore, in indoor navigation, a visual odometry device is usually used to fuse data of a camera and data of an inertial sensor for positioning and orienting. When the visual odometry device is used, a blurred image captured by a camera, quick shaking of a device, and the like may be prone to interrupt navigation of the visual odometry device, and therefore, the navigation needs to be resumed.

In an existing navigation resumption method, feature points in an environment are usually collected by a camera for resumption of the navigation. However, it will be difficult to collect the feature points for resumption of the navigation in an open environment or other environments with insufficient feature points (for example, where the scenes are highly repeated).

The method described in this section is not necessarily a method that has been previously conceived or employed. It should not be assumed that any of the methods described in this section is considered to be the prior art just because they are included in this section, unless otherwise indicated expressly. Similarly, the problem mentioned in this section should not be considered to be universally recognized in any prior art, unless otherwise indicated expressly.

### SUMMARY

The present disclosure provides a navigation method, apparatus, and device, an electronic device, a computer-readable storage medium, and a computer program product.

According to one aspect of the present disclosure, a navigation method is provided, w including: in response to resuming navigation after interruption, calculating an initial angle of an inertial sensor based on an angle of a gyroscope included in the inertial sensor, wherein the inertial sensor is included in a visual odometry device; and continuing the navigation based on the initial angle of the inertial sensor and a position of the visual odometry device before the interruption.

According to still another aspect of the present disclosure, a navigation device is provided, including: a visual odometry device including an inertial sensor, where the inertial sensor includes a gyroscope; and a navigator, where the navigator comprises a processor configured to execute the navigation method described in the present disclosure.

According to still another aspect of the present disclosure, a non-transitory computer-readable storage medium storing computer instructions is provided, when executed by a processor, the computer instructions are used to cause a computer to execute the navigation method described in the present disclosure.

According to still another aspect of the present disclosure, a computer program product is provided, including a computer program, where when the computer program is executed by a processor, the navigation method described in the present disclosure is implemented.

It should be understood that the content described in this section is not intended to identify critical or important features of the embodiments of the present disclosure, and is not used to limit the scope of the present disclosure. Other features of the present disclosure will be easily understood through the following description.

### BRIEF DESCRIPTION OF THE DRAWINGS

The drawings exemplarily show embodiments and form a part of the specification, and are used to explain exemplary implementations of the embodiments together with a written description of the specification. The embodiments shown are merely for illustrative purposes and do not limit the scope of the claims. Throughout the drawings, identical reference signs denote similar but not necessarily identical elements.

FIG. 1 shows a diagram of a scenario of indoor navigation according to an embodiment of the present disclosure;

FIG. 2 shows a flowchart of a navigation method according to an embodiment of the present disclosure;

FIG. 3 shows a flowchart of a navigation method according to an embodiment of the present disclosure;

FIG. 4 shows a flowchart of an example process of continuing navigation based on an initial angle of an inertial sensor and a position of a visual odometry device before interruption in the methods of FIG. 2 and FIG. 3 according to an embodiment of the present disclosure;

FIG. 5 shows a state diagram of a visual odometry device according to an embodiment of the present disclosure;

FIG. 6 shows a structural block diagram of a navigation apparatus for a visual odometry device according to an embodiment of the present disclosure;

FIG. 7 shows a structural block diagram of a navigation apparatus for a visual odometry device according to an embodiment of the present disclosure;

FIG. 8 is a structural block diagram of a navigation device according to an embodiment of the present disclosure; and

FIG. 9 is a structural block diagram of an exemplary electronic device that can be used to implement an embodiment of the present disclosure.

### DETAILED DESCRIPTION OF EMBODIMENTS

Exemplary embodiments of the present disclosure are described below in conjunction with the accompanying drawings, wherein various details of the embodiments of the present disclosure are included to facilitate understanding, and should only be considered as exemplary. Therefore, those of ordinary skill in the art should be aware that various changes and modifications can be made to the embodiments described herein, without departing from the scope of the present disclosure. Likewise, for clarity and conciseness, description of well-known functions and structures are omitted in the following descriptions.

In the present disclosure, unless otherwise stated, the terms “first”, “second”, etc., used to describe various elements are not intended to limit the positional, temporal or importance relationship of these elements, but rather only to distinguish one component from another. In some examples, the first element and the second element may refer to the same instance of the element, and in some cases, based on contextual descriptions, the first element and the second element may also refer to different instances.

The terms used in the description of the various examples in the present disclosure are merely for the purpose of describing particular examples, and are not intended to be limiting. If the number of elements is not specifically defined, there may be one or more elements, unless otherwise expressly indicated in the context. Moreover, the term “and/or” used in the present disclosure encompasses any of and all possible combinations of listed items.

Embodiments of the present disclosure will be described below in detail in conjunction with the drawings.

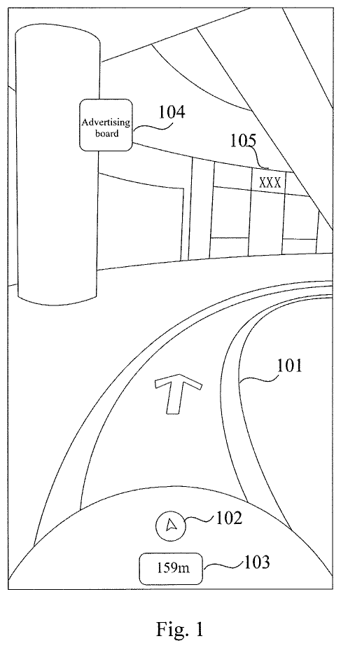

FIG. 1 shows a diagram of a scenario of indoor navigation according to an embodiment of the present disclosure.

As shown in FIG. 1, in indoor navigation, with virtuality and reality combined, virtual path indicators are shown in a real-world scene picture, for example, a navigation path 101, a compass 102, and an estimated travel distance 103, allowing a user to clearly know a navigation route. For navigation and guidance, a current position and a current direction need to be determined to calculate a path to a destination.

Specifically, to determine the current position and the current direction, the following operations need to be performed:

1) A reference point for navigation is determined. For example, a position and a direction of the reference point are determined, wherein the position of the reference point is a latitude position and a longitude position of the reference point, and the direction of the reference point includes a yaw angle component, a pitch angle component, and a roll angle component of the reference point.

2) Continuous tracking is performed based on the reference point for the navigation to determine variations relative to the position and the direction of the reference point, so that a current position and a current direction can be determined.

It can be seen that once navigation is interrupted, the reference point needs to be redetermined for tracking again.

In the prior art, a camera is usually used to collect feature points in an environment (for example, an advertising board 104 and a sign board 105 in FIG. 1) to calculate the reference point. However, this method for collecting the feature points is not applicable to an environment with insufficient feature points (for example, an open environment or an environment with highly repeated scenes).

To solve the foregoing problem, an embodiment of the present disclosure provides a navigation method, wherein a visual odometry device includes an inertial sensor, the inertial sensor includes a gyroscope, and the navigation method includes: in response to resumption of navigation after interruption, calculating an initial angle of the inertial sensor based on an angle of the gyroscope; and continuing the navigation based on the initial angle of the inertial sensor and a position of the visual odometry device before the interruption.

In the embodiments of the present disclosure, the visual odometry device may be a device that integrates a camera and an inertial sensor to estimate a displacement and a posture for positioning, mapping, navigation, or the like. The visual odometry device may also be referred to as a visual-inertial system, a visual-inertial odometry (VIO), a visual-inertial navigation system (VINS), a visual-inertial simultaneous localization and mapping (VI-SLAM) system, or the like.

In the embodiments of the present disclosure, the inertial sensor may be a sensor that performs measurement by using inertial force of sensing mass, and the inertial sensor may also be referred to as an inertial measurement unit (IMU). For example, the inertial sensor may be a consumer-grade inertial sensor that includes an accelerometer and a gyroscope, or may be a high-precision inertial navigation system, a strapdown inertial navigation system, or the like.

In the embodiments of the present disclosure, the camera may be a monocular camera or a multi-view camera.

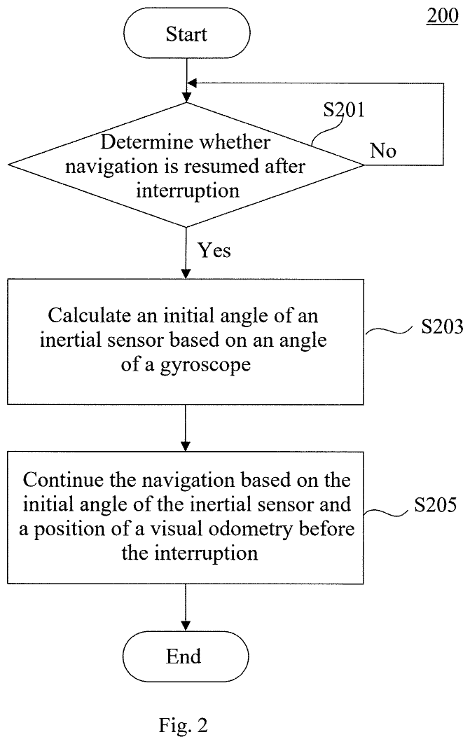

FIG. 2 shows a flowchart of a navigation method 200 according to an embodiment of the present disclosure.

At step S201, whether navigation is resumed after interruption is determined. If it is determined that the navigation is resumed after the interruption (“Yes” for step S201), the method proceeds to step S203; and if it is determined that the navigation is not resumed, the method goes back to step S201 to wait for the resumption of the navigation.

According to some embodiments, when a visual odometry device is used, anomalies such as a blurred image captures by a camera or quick shaking of a device may interrupt the navigation, and after the anomalies are eliminated, the navigation is resumed after the interruption. As described above, when the navigation is resumed after the interruption, a reference point for the navigation needs to be redetermined.

At step S203, an initial angle of the inertial sensor is calculated based on an angle of a gyroscope.

According to some embodiments, after the navigation is interrupted, the gyroscope still continuously tracks a varying direction, and an angle of the inertial sensor is reset after the navigation is resumed, and therefore the initial angle of the inertial sensor can be restored based on the angle of the gyroscope. According to some embodiments, an angle of each of the gyroscope and the inertial sensor includes a yaw angle component, a pitch angle component, and a roll angle component.

At step S205, the navigation is continued based on the initial angle of the inertial sensor and a position of the visual odometry device before the interruption.

According to some embodiments, the initial angle of the visual odometry device is determined based on the initial angle of the inertial sensor to determine a direction of the reference point, for example, the initial angle of the visual odometry device is set as the initial angle of the inertial sensor.

According to some embodiments, an initial position of the visual odometry device is calculated based on the position of the visual odometry device before the interruption to determine a position of the reference point. According to some embodiments, the position of the visual odometry device before the interruption is the last position of the visual odometry device that is tracked before the interruption. For example, the initial position of the visual odometry device is set as the position of the visual odometry device before the interruption, or the initial position of the visual odometry device is calculated based on the initial position of the visual odometry device and a moving speed and direction before the interruption.

As described above, after the reference point for the navigation is redetermined, tracking is performed again based on the redetermined reference point.

In the navigation method provided in the embodiments of the present disclosure, a camera is not required to collect feature points in an environment, and navigation can still be rapidly resumed in an environment where it is difficult to collect feature points, thereby improving robustness of navigation.

According to some embodiments, the navigation method described in the present disclosure further includes: before the calculating an initial angle of the inertial sensor based on an angle of a gyroscope, in response to the navigation being performed, calculating an angle conversion relationship between the gyroscope and the inertial sensor, wherein the calculating an initial angle of the inertial sensor based on an angle of a gyroscope includes: calculating the initial angle of the inertial sensor based on the angle of the gyroscope and the angle conversion relationship between the gyroscope and the inertial sensor.

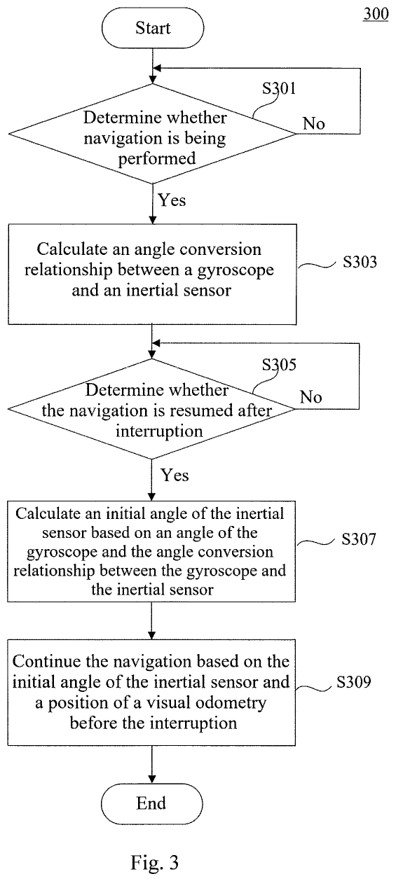

FIG. 3 shows a flowchart of a navigation method 300 according to an embodiment of the present disclosure.

At step S301, whether navigation is being performed is determined. If it is determined that the navigation is being performed (“Yes” for step S301), the method proceeds to step S303; and if it is determined that the navigation is not being performed, the method goes back to step S301.

At step S303, an angle conversion relationship between a gyroscope and an inertial sensor is calculated.

According to some embodiments, the angle conversion relationship between the gyroscope and the inertial sensor is calculated based on an angle of the gyroscope and an angle of the inertial sensor when the navigation is being performed.

According to some embodiments, when the navigation is being performed, the angle conversion relationship between the gyroscope and the inertial sensor is calculated at intervals based on the angle of the gyroscope and the angle of the inertial sensor within such an interval, to ensure real-time performance of the angle conversion relationship between the gyroscope and the inertial sensor. According to some other embodiments, each time the visual odometry device starts navigation, the angle conversion relationship between the gyroscope and the inertial sensor is calculated.

According to some embodiments, an angle of each of the gyroscope and the inertial sensor includes a yaw angle component, a pitch angle component, and a roll angle component, and the angle conversion relationship between the gyroscope and the inertial sensor includes: a conversion relationship between the yaw angle component of the gyroscope and the yaw angle component of the inertial sensor; a conversion relationship between the pitch angle component of the gyroscope and the pitch angle component of the inertial sensor; and a conversion relationship between the roll angle component of the gyroscope and the roll angle component of the inertial sensor.

According to some embodiments, for each of the yaw angle component, the pitch angle component, and the roll angle component, the angle conversion relationship between the gyroscope and the inertial sensor is a linear conversion relationship, for example, the angle component of the inertial sensor is a linear function of the angle component of the gyroscope.

According to some embodiments, the calculating an angle conversion relationship between the gyroscope and the inertial sensor includes: subtracting a yaw angle offset from the yaw angle component of the gyroscope to obtain the yaw angle component of the inertial sensor; subtracting a pitch angle offset from the pitch angle component of the gyroscope to obtain the pitch angle component of the inertial sensor; and subtracting a roll angle offset from the roll angle component of the gyroscope to obtain the roll angle component of the inertial sensor.

According to some embodiments, the calculating an angle conversion relationship between the gyroscope and the inertial sensor includes: for each of the yaw angle component, the pitch angle component, and the roll angle component, subtracting the angle component of the inertial sensor from the angle component of the gyroscope to obtain an offset corresponding to the angle component.

At step S305, whether navigation is resumed after interruption is determined. If it is determined that the navigation is resumed after the interruption (“Yes” for step S305), the method proceeds to step S307; and if it is determined that the navigation is not resumed, the method goes back to step S305 to wait for the resumption of the navigation. According to some embodiments, step S305 may, for example, be implemented similarly to step S201 in FIG. 2.

At step S307, an initial angle of the inertial sensor is calculated based on the angle of the gyroscope and the angle conversion relationship between the gyroscope and the inertial sensor.

According to some embodiments, for each of the yaw angle component, the pitch angle component, and the roll angle component, the angle component of the inertial sensor is calculated based on the angle component of the gyroscope and the angle conversion relationship corresponding to the angle component.

According to some embodiments, for each of the yaw angle component, the pitch angle component, and the roll angle component, the offset corresponding to the angle component is subtracted from the angle component of the gyroscope to obtain the angle component of the inertial sensor.

At step S309, the navigation is continued based on the initial angle of the inertial sensor and a position of the visual odometry device before the interruption. According to some embodiments, step S309 may, for example, be implemented similarly to step S205 in FIG. 2.

According to some embodiments, the continuing the navigation based on the initial angle of the inertial sensor and a position of the visual odometry device before the interruption includes: setting an initial angle of the visual odometry device as the initial angle of the inertial sensor; setting an initial position of the visual odometry device as the position of the visual odometry device before the interruption; and continuing the navigation based on the initial angle and the initial position of the visual odometry device.

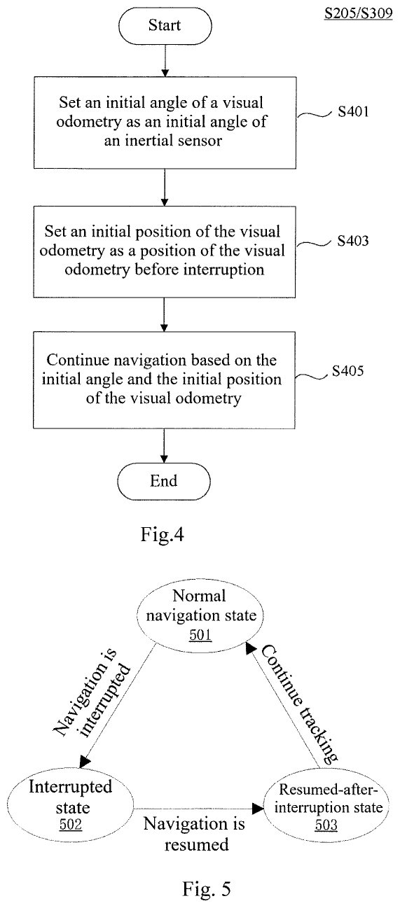

FIG. 4 shows a flowchart of an example process of continuing navigation (step S205 or step S309) based on an initial angle of an inertial sensor and a position of a visual odometry device before interruption in the methods of FIG. 2 and FIG. 3 according to an embodiment of the present disclosure.

At step S401, an initial angle of the visual odometry device is set as the initial angle of the inertial sensor. According to some embodiments, the initial angle of the inertial sensor is the initial angle of the inertial sensor that is calculated based on the angle of the gyroscope described with reference to FIG. 2 or FIG. 3.

At step S403, an initial position of the visual odometry device is set as the position of the visual odometry device before the interruption. According to some embodiments, the position of the visual odometry device before the interruption is the last position of the visual odometry device that is tracked before the interruption.

At step S405, the navigation is continued based on the initial angle and the initial position of the visual odometry device.

According to some embodiments, the navigation method described in the present disclosure further includes: in response to the interruption of the navigation, sending an instruction to prompt a user to stop moving. For example, a message for prompting a user to stop moving is displayed by a display apparatus coupled to the visual odometry device, or a message for prompting a user to stop moving is played by a speaker coupled to the visual odometry device. When the user is stopped from further movement, the position is less likely to change before and after the interruption of the navigation, reducing position errors caused by setting the initial position of the visual odometry device as the position of the visual odometry device before the interruption.

FIG. 5 is a state diagram of a visual odometry device according to an embodiment of the present disclosure.

In a normal navigation state 501, a position and a direction are continuously tracked. In addition, as described in step S303 in FIG. 3, an angle conversion relationship between a gyroscope and an inertial sensor is calculated based on an angle of the gyroscope and an angle of the inertial sensor.

When navigation is interrupted, the visual odometry device is switched to an interrupted state 502. In this case, the gyroscope continuously tracks a varying direction, and may also send an instruction to prompt a user to stop moving.

When navigation is resumed, the visual odometry device is switched to a resumed-after-interruption state 503. In this case, as described in step S203 in FIG. 2 or step S307 in FIG. 3, an initial angle of the inertial sensor is calculated. For example, the initial angle of the inertial sensor is calculated based on the angle conversion relationship between the gyroscope and the inertial sensor that is calculated before the interruption to calculate an initial angle of the visual odometry device. In addition, an initial position of the visual odometry device is calculated based on the position of the visual odometry device before the interruption.

After the initial angle and the initial position of the visual odometry device are determined, the visual odometry device is switched to the normal navigation state 501. In this case, a direction and a position continue being tracked based on the initial angle and the initial position of the visual odometry device. In addition, as described above, the angle conversion relationship between the gyroscope and the inertial sensor is calculated based on the angle of the gyroscope and the angle of the inertial sensor.

According to another aspect of the present disclosure, a navigation apparatus is further provided, where a visual odometry device includes an inertial sensor, the inertial sensor includes a gyroscope, and the navigation apparatus includes: an angle restoration module configured to: in response to resumption of navigation after interruption, calculate an initial angle of the inertial sensor based on an angle of the gyroscope; and a navigation module configured to continue the navigation based on the initial angle of the inertial sensor and a position of the visual odometry device before the interruption.

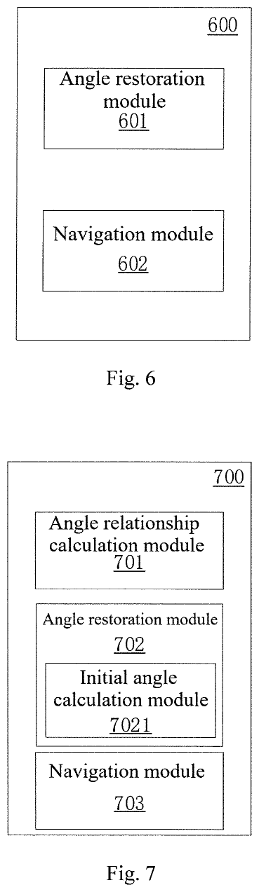

FIG. 6 is a structural block diagram of a navigation apparatus 600 according to an embodiment of the present disclosure.

As shown in FIG. 6, the navigation apparatus 600 includes an angle restoration module 601 and a navigation module 602, where the angle restoration module 601 is configured to: in response to resumption of navigation after interruption, calculate an initial angle of the inertial sensor based on an angle of the gyroscope; and the navigation module 602 is configured to continue the navigation based on the initial angle of the inertial sensor and a position of the visual odometry device before the interruption.

According to some embodiments, the navigation apparatus further includes: an angle relationship calculation module configured to: in response to the navigation being performed, calculate an angle conversion relationship between the gyroscope and the inertial sensor, where the angle restoration module includes: an initial angle calculation module configured to calculate the initial angle of the inertial sensor based on the angle of the gyroscope and the angle conversion relationship between the gyroscope and the inertial sensor.

FIG. 7 is a structural block diagram of a navigation apparatus 700 according to an embodiment of the present disclosure. As shown in FIG. 7, the navigation apparatus 700 includes an angle relationship calculation module 701, an angle restoration module 702, and a navigation module 703.

According to some embodiments, the angle relationship calculation module 701 is configured to: in response to the navigation being performed, calculate an angle conversion relationship between the gyroscope and the inertial sensor; the angle restoration module 702 includes an initial angle calculation module 7021, where the initial angle calculation module 7021 is configured to calculate the initial angle of the inertial sensor based on the angle of the gyroscope and the angle conversion relationship between the gyroscope and the inertial sensor; and in addition, the navigation module 703 may be implemented the same as the navigation module 602 in FIG. 6.

According to some embodiments, an angle of each of the gyroscope and the inertial sensor includes a yaw angle component, a pitch angle component, and a roll angle component, and the angle conversion relationship between the gyroscope and the inertial sensor includes: a conversion relationship between the yaw angle component of the gyroscope and the yaw angle component of the inertial sensor; a conversion relationship between the pitch angle component of the gyroscope and the pitch angle component of the inertial sensor; and a conversion relationship between the roll angle component of the gyroscope and the roll angle component of the inertial sensor.

According to some embodiments, the calculating an angle conversion relationship between the gyroscope and the inertial sensor includes: subtracting a yaw angle offset from the yaw angle component of the gyroscope to obtain the yaw angle component of the inertial sensor; subtracting a pitch angle offset from the pitch angle component of the gyroscope to obtain the pitch angle component of the inertial sensor; and subtracting a roll angle offset from the roll angle component of the gyroscope to obtain the roll angle component of the inertial sensor.

According to some embodiments, the navigation module includes: a reference point determination module configured to: set an initial angle of the visual odometry device as the initial angle of the inertial sensor; and set an initial position of the visual odometry device as the position of the visual odometry device before the interruption; and a navigation resumption module configured to continue the navigation based on the initial angle and the initial position of the visual odometry device.

According to some embodiments, the navigation apparatus further includes: an interruption prompt module configured to: in response to the interruption of the navigation, send an instruction to prompt a user to stop moving.

According to another aspect of the present disclosure, a navigation device is provided, including: a visual odometry device including an inertial sensor, where the inertial sensor includes a gyroscope; and a navigator, where the navigator comprises a processor configured to execute the steps of the foregoing method.

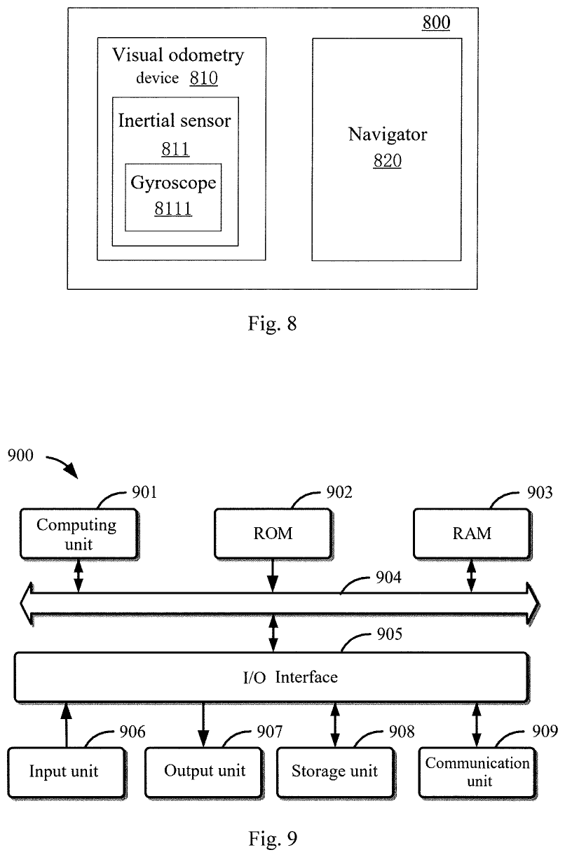

FIG. 8 is a structural block diagram of a navigation device 800 according to an embodiment of the present disclosure.

As shown in FIG. 8, the navigation device 800 includes a visual odometry device 810 and a navigator 820, where the visual odometry device 810 includes an inertial sensor 811, the inertial sensor 811 includes a gyroscope 8111, and the navigator 820 comprises a processor configured to execute the steps of the foregoing method.

According to the embodiments of the present disclosure, an electronic device, a readable storage medium, and a computer program product are further provided.

According to another aspect of the present disclosure, an electronic device is further provided, including: at least one processor and a memory communicatively connected to the at least one processor, where the memory stores instructions executable by the at least one processor, and when executed by the at least one processor, the instructions cause the at least one processor to execute a program to execute the steps of the foregoing method.

According to another aspect of the present disclosure, a non-transitory computer-readable storage medium storing computer instructions is further provided, where the computer instructions are used to cause a computer to execute the steps of the foregoing method.

According to another aspect of the present disclosure, a computer program product is further provided, including a computer program, where when the computer program is executed by a processor, the steps of the foregoing method are executed.

In the technical solutions of the present disclosure, obtaining, storage, application, etc. of personal information of a user all comply with related laws and regulations and are not against the public order and good morals.

Referring to FIG. 9, a structural block diagram of an electronic device 900 that can serve as a server or a client of the present disclosure is now described, which is an example of a hardware device that may be applied to various aspects of the present disclosure. The electronic device is intended to represent various forms of digital electronic computer devices, such as a laptop computer, a desktop computer, a workstation, a personal digital assistant, a server, a blade server, a mainframe computer, and other suitable computers. The electronic device may also represent various forms of mobile apparatuses, such as a personal digital assistant, a cellular phone, a smartphone, a wearable device, and other similar computing apparatuses. The components shown herein, their connections and relationships, and their functions are merely examples, and are not intended to limit the implementation of the present disclosure described and/or required herein.

As shown in FIG. 9, the device 900 includes a computing unit 901, which may perform various appropriate actions and processing according to a computer program stored in a read-only memory (ROM) 902 or a computer program loaded from a storage unit 908 to a random access memory (RAM) 903. The RAM 903 may further store various programs and data required for the operation of the device 900. The computing unit 901, the ROM 902, and the RAM 903 are connected to each other through a bus 904. An input/output (I/O) interface 905 is also connected to the bus 904.

A plurality of components in the device 900 are connected to the I/O interface 905, including: an input unit 906, an output unit 907, the storage unit 908, and a communication unit 909. The input unit 906 may be any type of device capable of entering information to the device 900. The input unit 906 may receive entered digit or character information, and generate a key signal input related to user settings and/or function control of the electronic device, and may include, but is not limited to, a mouse, a keyboard, a touchscreen, a trackpad, a trackball, a joystick, a microphone, and/or a remote controller. The output unit 907 may be any type of device capable of presenting information, and may include, but is not limited to, a display, a speaker, a video/audio output terminal, a vibrator, and/or a printer. The storage unit 908 may include, but is not limited to, a magnetic disk and an optical disc. The communication unit 909 allows the device 900 to exchange information/data with other devices via a computer network such as the Internet and/or various telecommunications networks, and may include, but is not limited to, a modem, a network interface card, an infrared communication device, a wireless communication transceiver and/or a chipset, e.g., a Bluetooth™ device, a 1302.11 device, a Wi-Fi device, a WiMax device, a cellular communication device and/or the like.

The computing unit 901 may be various general-purpose and/or special-purpose processing components with processing and computing capabilities. Some examples of the computing unit 901 include, but are not limited to, a central processing unit (CPU), a graphics processing unit (GPU), various dedicated artificial intelligence (AI) computing chips, various computing units that run machine learning model algorithms, a digital signal processor (DSP), and any appropriate processor, controller, microcontroller, and the like. The computing unit 901 performs the various methods and processing described above, for example, the method 200 or 300. For example, in some embodiments, the method 200 or 300 may be implemented as a computer software program, which is tangibly contained in a machine-readable medium, such as the storage unit 908. In some embodiments, a part or all of the computer program may be loaded and/or installed onto the device 900 via the ROM 902 and/or the communication unit 909. When the computer program is loaded onto the RAM 903 and executed by the computing unit 901, one or more steps of the method 200 or 300 described above can be performed. Alternatively, in other embodiments, the computing unit 901 may be configured, by any other suitable means (for example, by means of firmware), to perform the method 200 or 300.

Various implementations of the systems and technologies described herein above may be implemented in a digital electronic circuit system, an integrated circuit system, a field programmable gate array (FPGA), an application-specific integrated circuit (ASIC), an application-specific standard product (ASSP), a system-on-chip (SOC) system, a complex programmable logical device (CPLD), computer hardware, firmware, software, and/or a combination thereof. These various implementations may include: The systems and technologies are implemented in one or more computer programs, where the one or more computer programs may be executed and/or interpreted on a programmable system including at least one programmable processor. The programmable processor may be a dedicated or general-purpose programmable processor that can receive data and instructions from a storage system, at least one input apparatus, and at least one output apparatus, and transmit data and instructions to the storage system, the at least one input apparatus, and the at least one output apparatus.

Program codes used to implement the method of the present disclosure may be written in any combination of one or more programming languages. These program codes may be provided for a processor or a controller of a general-purpose computer, a special-purpose computer, or other programmable data processing apparatuses, such that when the program codes are executed by the processor or the controller, the functions/operations specified in the flowcharts and/or block diagrams are implemented. The program codes may be completely executed on a machine, or partially executed on a machine, or may be, as an independent software package, partially executed on a machine and partially executed on a remote machine, or completely executed on a remote machine or a server.

In the context of the present disclosure, the machine-readable medium may be a tangible medium, which may contain or store a program for use by an instruction execution system, apparatus, or device, or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In order to provide interaction with a user, the systems and technologies described herein may be implemented on a computer which has: a display apparatus (for example, a cathode-ray tube (CRT) or a liquid crystal display (LCD) monitor) configured to display information to the user; and a keyboard and a pointing apparatus (for example, a mouse or a trackball) through which the user can provide an input to the computer. Other types of apparatuses may also be used to provide interaction with the user; for example, a feedback provided to the user may be any form of sensory feedback (for example, a visual feedback, an auditory feedback, or a tactile feedback), and an input from the user may be received in any form (including an acoustic input, a voice input, or a tactile input).

The systems and technologies described herein may be implemented in a computing system (for example, as a data server) including a backend component, or a computing system (for example, an application server) including a middleware component, or a computing system (for example, a user computer with a graphical user interface or a web browser through which the user can interact with the implementation of the systems and technologies described herein) including a frontend component, or a computing system including any combination of the backend component, the middleware component, or the frontend component. The components of the system can be connected to each other through digital data communication (for example, a communications network) in any form or medium. Examples of the communications network include: a local area network (LAN), a wide area network (WAN), and the Internet.

A computer system may include a client and a server. The client and the server are generally far away from each other and usually interact through a communications network. A relationship between the client and the server is generated by computer programs running on respective computers and having a client-server relationship with each other. The server may be a cloud server, a server in a distributed system, or a server combined with a blockchain.

It should be understood that steps may be reordered, added, or deleted based on the various forms of procedures shown above. For example, the steps described in the present disclosure may be performed in parallel, sequentially, or in a different order, provided that the desired result of the technical solutions disclosed in the present disclosure can be achieved, which is not limited herein.

Although the embodiments or examples of the present disclosure have been described with reference to the drawings, it should be appreciated that the methods, systems, and devices described above are merely exemplary embodiments or examples, and the scope of the present invention is not limited by the embodiments or examples, but only defined by the appended claims when allowed and equivalent scopes thereof. Various elements in the embodiments or examples may be omitted or substituted by equivalent elements thereof. Moreover, the steps may be performed in an order different from that described in the present disclosure. Further, various elements in the embodiments or examples may be combined in various ways. It is important that, as the technology evolves, many elements described herein may be replaced with equivalent elements that appear after the present disclosure.

What is claimed is:

1. A navigation method, comprising:
in response to resuming navigation after interruption, calculating an initial angle of an inertial sensor based on an angle of a gyroscope included in the inertial sensor, wherein the inertial sensor is included in a visual odometry device; and
continuing the navigation based on the initial angle of the inertial sensor and a position of the visual odometry device before the interruption.

2. The navigation method according to claim 1, further comprising:
before the calculating the initial angle of the inertial sensor based on the angle of the gyroscope, and in response to the navigation being performed, calculating an angle conversion relationship between the gyroscope and the inertial sensor,
wherein the calculating the initial angle of the inertial sensor based on the angle of the gyroscope comprises:
calculating the initial angle of the inertial sensor based on the angle of the gyroscope and the angle conversion relationship between the gyroscope and the inertial sensor.

3. The navigation method according to claim 2,
wherein an angle of each of the gyroscope and the inertial sensor comprises a yaw angle component, a pitch angle component, and a roll angle component; and
wherein the angle conversion relationship between the gyroscope and the inertial sensor comprises:
a first conversion relationship between the yaw angle component of the gyroscope and the yaw angle component of the inertial sensor;
a second conversion relationship between the pitch angle component of the gyroscope and the pitch angle component of the inertial sensor; and
a third conversion relationship between the roll angle component of the gyroscope and the roll angle component of the inertial sensor.

4. The navigation method according to claim 3, wherein the angle conversion relationship between the gyroscope and the inertial sensor is based on:
subtracting a yaw angle offset from the yaw angle component of the gyroscope to obtain the yaw angle component of the inertial sensor;
subtracting a pitch angle offset from the pitch angle component of the gyroscope to obtain the pitch angle component of the inertial sensor; and
subtracting a roll angle offset from the roll angle component of the gyroscope to obtain the roll angle component of the inertial sensor.

5. The navigation method according to claim 1, wherein the continuing the navigation based on the initial angle of the inertial sensor and the position of the visual odometry device before the interruption comprises:
setting an initial angle of the visual odometry device as the initial angle of the inertial sensor;
setting an initial position of the visual odometry device as the position of the visual odometry device before the interruption; and
continuing the navigation based on the initial angle of the inertial sensor and the initial position of the visual odometry device.

6. The navigation method according to claim 5, further comprising:
in response to the interruption of the navigation, sending an instruction to prompt a user to stop moving.

7. A navigation device, comprising:
a visual odometry device comprising an inertial sensor, wherein the inertial sensor comprises a gyroscope; and
a processor configured to execute:
in response to resuming navigation after interruption, calculating an initial angle of the inertial sensor based on an angle of the gyroscope; and
continuing the navigation based on the initial angle of the inertial sensor and a position of the visual odometry device before the interruption.

8. The navigation device according to claim 7, wherein the processor is further configured to execute:
before the calculating the initial angle of the inertial sensor based on the angle of the gyroscope, and in response to the navigation being performed, calculating an angle conversion relationship between the gyroscope and the inertial sensor,
wherein the calculating the initial angle of the inertial sensor based on the angle of the gyroscope comprises:
calculating the initial angle of the inertial sensor based on the angle of the gyroscope and the angle conversion relationship between the gyroscope and the inertial sensor.

9. The navigation device according to claim 8,
wherein an angle of each of the gyroscope and the inertial sensor comprises a yaw angle component, a pitch angle component, and a roll angle component; and
wherein the angle conversion relationship between the gyroscope and the inertial sensor comprises:
a first conversion relationship between the yaw angle component of the gyroscope and the yaw angle component of the inertial sensor;
a second conversion relationship between the pitch angle component of the gyroscope and the pitch angle component of the inertial sensor; and
a third conversion relationship between the roll angle component of the gyroscope and the roll angle component of the inertial sensor.

10. The navigation device according to claim 9, wherein the angle conversion relationship between the gyroscope and the inertial sensor is based on:
subtracting a yaw angle offset from the yaw angle component of the gyroscope to obtain the yaw angle component of the inertial sensor;
subtracting a pitch angle offset from the pitch angle component of the gyroscope to obtain the pitch angle component of the inertial sensor; and
subtracting a roll angle offset from the roll angle component of the gyroscope to obtain the roll angle component of the inertial sensor.

11. The navigation device according to claim 7, wherein the continuing the navigation based on the initial angle of the inertial sensor and the position of the visual odometry device before the interruption comprises:
setting an initial angle of the visual odometry device as the initial angle of the inertial sensor;
setting an initial position of the visual odometry device as the position of the visual odometry device before the interruption; and
continuing the navigation based on the initial angle of the inertial sensor and the initial position of the visual odometry device.

12. The navigation device according to claim 7, wherein the processor is further configured to execute:
in response to the interruption of the navigation, sending an instruction to prompt a user to stop moving.

13. A non-transitory computer-readable storage medium storing computer instructions that, when executed by a processor, cause a computer to execute:
in response to resuming navigation after interruption, calculating an initial angle of an inertial sensor based on an angle of a gyroscope included in the inertial sensor, wherein the inertial sensor is included in a visual odometry device; and
continuing the navigation based on the initial angle of the inertial sensor and a position of the visual odometry device before the interruption.

14. The non-transitory computer-readable storage medium according to claim 13, wherein the computer instructions, when executed by the processor, further cause the computer to execute:
before the calculating the initial angle of the inertial sensor based on the angle of the gyroscope, and in response to the navigation being performed, calculating an angle conversion relationship between the gyroscope and the inertial sensor,
wherein the calculating the initial angle of the inertial sensor based on the angle of the gyroscope comprises:
calculating the initial angle of the inertial sensor based on the angle of the gyroscope and the angle conversion relationship between the gyroscope and the inertial sensor.

15. The non-transitory computer-readable storage medium according to claim 14,
wherein an angle of each of the gyroscope and the inertial sensor comprises a yaw angle component, a pitch angle component, and a roll angle component; and
wherein the angle conversion relationship between the gyroscope and the inertial sensor comprises:
a first conversion relationship between the yaw angle component of the gyroscope and the yaw angle component of the inertial sensor;
a second conversion relationship between the pitch angle component of the gyroscope and the pitch angle component of the inertial sensor; and
a third conversion relationship between the roll angle component of the gyroscope and the roll angle component of the inertial sensor.

16. The non-transitory computer-readable storage medium according to claim 15, wherein the angle conversion relationship between the gyroscope and the inertial sensor is based on:
subtracting a yaw angle offset from the yaw angle component of the gyroscope to obtain the yaw angle component of the inertial sensor;
subtracting a pitch angle offset from the pitch angle component of the gyroscope to obtain the pitch angle component of the inertial sensor; and
subtracting a roll angle offset from the roll angle component of the gyroscope to obtain the roll angle component of the inertial sensor.

17. The non-transitory computer-readable storage medium according to claim 13, wherein the continuing the navigation based on the initial angle of the inertial sensor and the position of the visual odometry device before the interruption comprises:
setting an initial angle of the visual odometry device as the initial angle of the inertial sensor;
setting an initial position of the visual odometry device as the position of the visual odometry device before the interruption; and
continuing the navigation based on the initial angle of the inertial sensor and the initial position of the visual odometry device.

18. The non-transitory computer-readable storage medium according to claim 13, wherein the computer instructions are further used to cause the computer to execute:
in response to the interruption of the navigation, sending an instruction to prompt a user to stop moving.
